(19) United States
(12) Patent Application Publication
(10) Pub. No.: US 2024/0388463 A1
(43) Pub. Date: Nov. 21, 2024

(54) REACTION PRESENTATION CONTROL DEVICE, METHOD AND PROGRAM

(71) Applicant: NIPPON TELEGRAPH AND TELEPHONE CORPORATION, Tokyo (JP)

(72) Inventors: Naoki HAGIYAMA, Musashino-shi, Tokyo (JP); Mana SASAGAWA, Musashino-shi, Tokyo (JP); Ayaka SANO, Musashino-shi, Tokyo (JP); Shunichi SEKO, Musashino-shi, Tokyo (JP); Ryuji YAMAMOTO, Musashino-shi, Tokyo (JP)

(73) Assignee: NIPPON TELEGRAPH AND TELEPHONE CORPORATION, Tokyo (JP)

(21) Appl. No.: 18/696,369

(22) PCT Filed: Oct. 14, 2021
(86) PCT No.: PCT/JP2021/038003

§ 371 Date: Mar. 28, 2024

(51) Int. Cl. H04L 12/18; G06V 40/20; G08B 6/00

(52) U.S. Cl. CPC H04L 12/1831; G06V 40/20; G08B 6/00

(57) ABSTRACT

According to one embodiment of the present invention, information indicating reaction states of a plurality of listeners to an event is acquired, and reaction aggregation information in which the reaction states of the plurality of listeners are aggregated is generated based on the acquired information indicating the reaction states. Then, control information for variably controlling vibration and temperature is generated based on the generated reaction aggregation information, and the generated control information is output to be presented to a speaker of the event.

### TECHNICAL FIELD

One embodiment of the present invention relates to a reaction presentation control apparatus, method, and program for presenting a reaction of a listener to a speaker in an event such as a conference, a lecture, or an exhibition.

### BACKGROUND ART

For example, in order to improve quality of events, it is important to understand reactions of listeners in events such as conferences, lectures, and exhibitions. As a scheme of understanding reactions of listeners, for example, questionnaire surveys are common, but there is a problem that the reactions of the listeners cannot be understood in real time.

Accordingly, for example, as described in Non Patent Literature 1, a scheme of detecting a reaction of a listener during an event using a sensor or the like and presenting a result of the detection to a speaker with an avatar has been proposed. For example, as described in Non Patent Literature 2, a scheme of detecting nodding of a listener and presenting a timing of the nodding to a speaker using the sense of vision or touch has been proposed.

### CITATION LIST

### Non Patent Literature

Non Patent Literature 1: Kaito Yoshida, et. al “Choshu hanno wo tannitsu abata ni shuyaku suru koto ni yoru enkaku kogi shien shisutemu no kaihatsu (in Japanese) (Development of Remote Lecture Support System by Aggregating Audience Reaction into Single Avatar)”, papers of the 23rd Annual Conference of Virtual Reality Society of Japan 13C-2, 2018 Non Patent Literature 2: Hiroshi Nagai, Tomio Watanabe, Tomiya Yamamoto, “A Speech-Driven Embodied Entrainment System with Visualized and Vibratory Nodding Responses as Listener (Mechanical Systems)”, Transactions of the Japan Society of Mechanical Engineers Series C 75.755 (2009):2059-2067.

### SUMMARY OF INVENTION

### Technical Problem

However, in the scheme described in Non Patent Literature 1, both a material and an avatar are required to be viewed in a scene where a speaker is already using visual information, for example, in a case where a speaker is speaking while looking at the material. Therefore, there is a problem that a cognitive load of the speaker increases and it is difficult to clearly recognize reactions of the listeners.

On the other hand, in the scheme described in Non Patent Literature 2, since the reactions of the listeners are presented using the sense of touch in a scene where the speaker has already been using the visual information, it is possible to present the reactions of the listeners to the speaker with a smaller cognitive load as compared with the case where the visual information is used. However, in the scheme described in Non Patent Literature 2, only a timing of nodding of the listeners is presented. Therefore, the speaker cannot clearly recognize the reactions of the listeners, for example, even if the speaker wants to know the reactions of the listeners including content of a description.

The present invention has been devised in view of the foregoing circumstances, and an object of the present invention is to provide a technique for enabling a speaker to recognize reaction states of listeners in more detail with a small cognitive load.

### Solution to Problem

In order to solve the above problems, according to an aspect of the present invention, in a reaction presentation control apparatus or a reaction presentation control method, information indicating each of reaction states of a plurality of listeners to speech content of a speaker is acquired, and reaction aggregation information obtained by aggregating the reaction states of the plurality of listeners is generated based on the acquired information indicating the reaction states. Then, control information for variably controlling vibration and temperature is generated based on the generated reaction aggregation information and the generated control information is output to be presented to the speaker.

According to one aspect of the present invention, for example, in an event such as a conference, a lecture, or an exhibition, information indicating reaction states of a plurality of listeners to speech content of a speaker is acquired and aggregated, and an aggregation result of the reaction states is presented to the speaker by using a combination of vibration and temperature. Therefore, the speaker can recognize the reaction states of the plurality of listeners in the event in more detail with a smaller cognitive load as compared with the case where only visual display or vibration is used.

### Advantageous Effects of Invention

That is, according to one aspect of the present invention, it is possible to provide a technique for enabling a speaker to recognize reaction states of listeners in more detail with a small cognitive load.

### BRIEF DESCRIPTION OF DRAWINGS

FIG. 1 is a diagram illustrating an example of a configuration of an online conference system including a reaction presentation control apparatus according to an embodiment of the present invention.

FIG. 2 is a block diagram illustrating an example of a configuration of a listener terminal used by a listener in the system illustrated in FIG. 1.

FIG. 3 is a block diagram illustrating an example of a configuration of a server apparatus used as a reaction presentation control apparatus in the system illustrated in FIG. 1.

FIG. 4 is a block diagram illustrating an example of a configuration of a speaker terminal used by a speaker in the system illustrated in FIG. 1.

FIG. 5 is a flowchart illustrating a processing procedure and processing content of a reaction detection process executed by a control unit of the listener terminal illustrated in FIG. 2.

FIG. 6 is a flowchart illustrating a processing procedure and processing content of a reaction presentation control process executed by a control unit of the server apparatus illustrated in FIG. 3.

FIG. 7 is a flowchart illustrating a processing procedure and processing content of a reaction presentation process executed by the control unit of the speaker terminal illustrated in FIG. 4.

FIG. 8 is a diagram illustrating an example of a reaction presentation result presented by combining vibration and temperature.

### DESCRIPTION OF EMBODIMENTS

Hereinafter, embodiments according to the present invention will be described with reference to the drawings.

### Embodiment

### Configuration Example

### (1) System

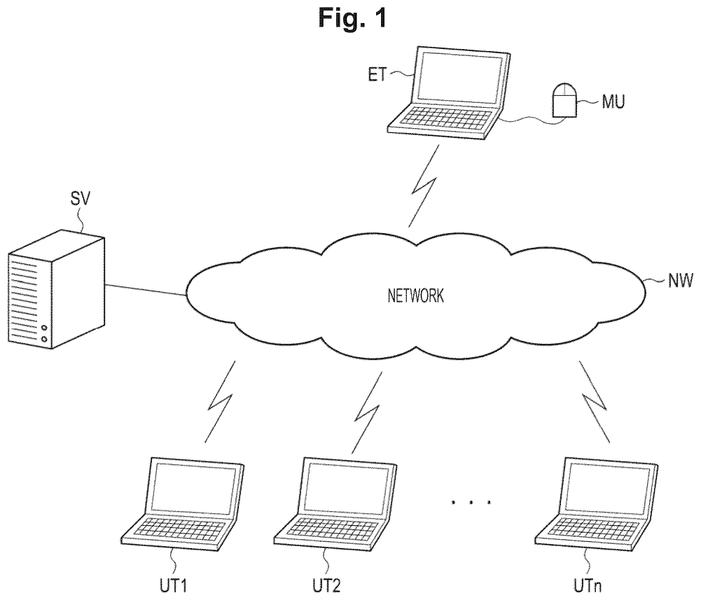

FIG. 1 is a diagram illustrating an example of a configuration of an online conference system including a reaction presentation control apparatus according to an embodiment of the present invention.

An online conference system according to an embodiment includes a server apparatus SV that has a function as a reaction presentation control apparatus, and enables transmission of information data via a network NW between the server apparatus SV, a speaker terminal ET used by a speaker, and a plurality of listener terminals UT1 to UTn used by each of a plurality of listeners.

The network NW includes, for example, a wide area network having the Internet as a core and an access network for accessing the wide area network. As the access network, for example, a public communication network in which a wired or wireless network is used, a local area network (LAN) in which a wired or wireless network is used, or a cable television (CATV) network is used.

### (2) Apparatus

### (2-1) Listener Terminals UT1 to UTn

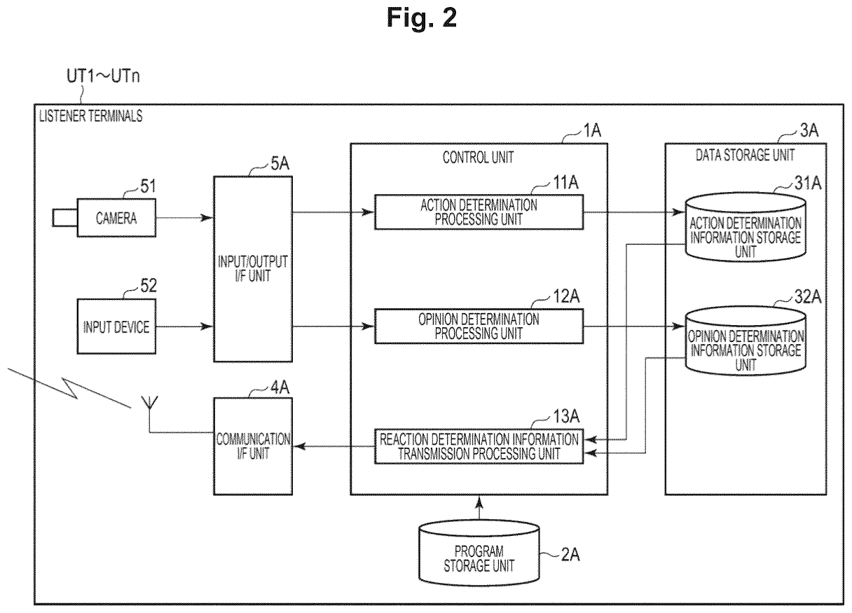

FIG. 2 is a block diagram illustrating an example of a hardware and software configuration of the listener terminals UT1 to UTn.

The listener terminals UT1 to UTn are, for example, personal computers that have an online conference function. As the listener terminals UT1 to UTn, other tablet terminals, smartphones, and the like may be used as long as they have similar functions.

Each of the listener terminals UT1 to UTn includes a control unit 1A in which a hardware processor such as a central processing unit (CPU) is used. Further, a storage unit including a program storage unit 2A and a data storage unit 3A, a communication interface (hereinafter referred to as an I/F) unit 4A, and an input/output I/F unit 5A are connected to the control unit 1A via a bus (not illustrated).

The communication I/F unit 4A performs data communication with the server apparatus SV in conformity with a communication protocol defined by the network NW under the control of the control unit 1A.

A camera 51 and an input device 52 are connected to the input/output I/F unit 5A. The camera 51 is used to capture face images of listeners while the listeners participate in a conference in this example. The input device 52 includes, for example, a keyboard and a mouse, and is used by a listener to input his or her opinion while participating in the conference. Additionally, a display device (not illustrated) is connected to the input/output I/F unit 5A, and a captured image of the speaker and a conference material can be displayed by the display device.

For example, the program storage unit 2A is configured by combining a nonvolatile memory such as a solid state drive (SSD) capable of performing writing and reading, as necessary, and a nonvolatile memory such as a read only memory (ROM) as a storage medium, and stores an application program necessary for executing various control processes according to an embodiment, in addition to middleware such as an operating system (OS). Hereinafter, the OS and each application program are collectively referred to as a program.

The data storage unit 3A is, for example, a combination of a nonvolatile memory such as an SSD in which reading and reading can be performed, as necessary, and a volatile memory such as a random access memory (RAM), as a storage medium, and includes an action determination information storage unit 31A and an opinion determination information storage unit 32A as main storage units necessary for carrying out one embodiment.

The action determination information storage unit 31A is used to store a result of determination performed by the control unit 1A to be described below with regard to an action in which a reaction shown by a listener participating in the conference to the speech content of the speaker is reflected.

The opinion determination information storage unit 32A is used to store a result of determination performed by the control unit 1A to be described below with regard to an opinion input by a listener participating in the conference about the speech content of the speaker.

The control unit 1A includes an action determination processing unit 11A, an opinion determination processing unit 12A, and a reaction determination information transmission processing unit 13A as processing functions necessary for carrying out one embodiment. Each of the processing units 11A to 13A is implemented by causing a hardware processor of the control unit 1A to execute an application program stored in the program storage unit 2A. The application program may be downloaded from the server apparatus SV as necessary and may be stored in the program storage unit 2A, in addition to being stored in advance in the program storage unit 2A.

The action determination processing unit 11A performs processing for capturing video data of the faces or the upper bodies of the listeners captured by the camera 51 while the listeners participate in the conference via the input/output I/F unit 5A, determining actions reflecting the reactions of the listeners based on the captured video data, and storing information indicating a determination result in the action determination information storage unit 31A.

The opinion determination processing unit 12A performs processing for capturing, via the input/output I/F unit 5A, information indicating opinions on the speech content input by the listeners with the input device 52 while the listeners participate in the conference, determining the opinion based on the captured information, and storing information indicating a determination result in the opinion determination information storage unit 32A.

The reaction determination information transmission processing unit 13A performs processing for reading information indicating the determination result of the actions and the determination result of the opinions from the action determination information storage unit 31A and the opinion determination information storage unit 32A, respectively, periodically or at any timing, inserting each read determination result into, for example, one packet, and transmitting the packet from the communication I/F unit 4A to the server apparatus SV.

### (2-2) Server Apparatus SV

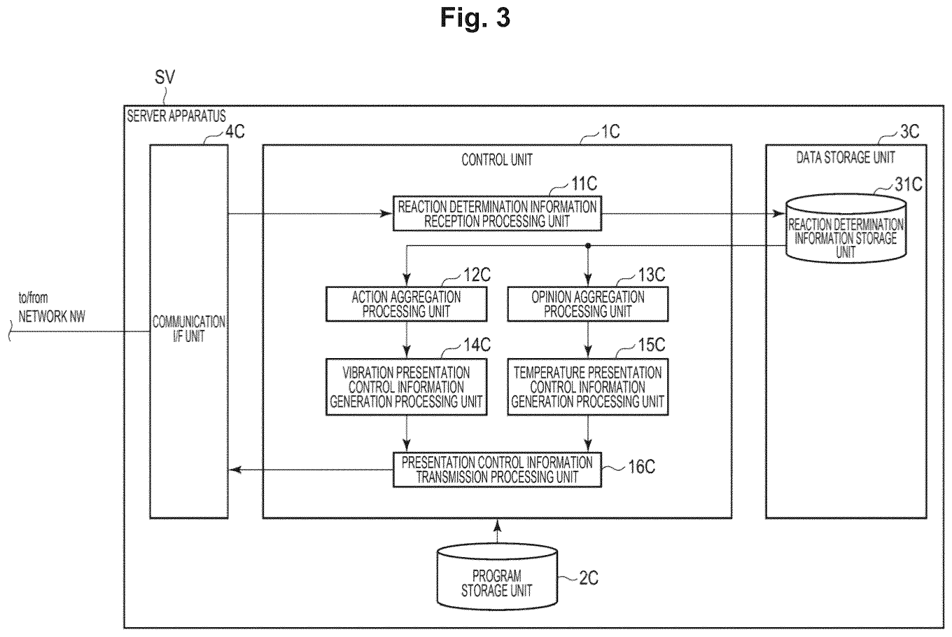

FIG. 3 is a block diagram illustrating an example of a hardware and software configuration of the server apparatus SV.

The server apparatus SV includes, for example, a server computer located on a cloud, and includes a control unit 1C in which a hardware processor such as a CPU is used. Then, a storage unit including a program storage unit 2C and a data storage unit 3C and a communication I/F unit 4C are connected to the control unit 1C via a bus (not illustrated).

The communication I/F unit 4C transmits and receives information data to and from the speaker terminal ET and the listener terminals UT1 to UTn in conformity with a communication protocol defined by the network NW under the control of the control unit 1C.

For example, the program storage unit 2C is configured by combining a nonvolatile memory such as an HDD or an SSD capable of performing writing and reading, as necessary, and a nonvolatile memory such as a ROM as a storage medium, and stores a program necessary for executing various control processes according to an embodiment of the present invention, in addition to middleware such as an OS.

The data storage unit 3C is, for example, a combination of a nonvolatile memory such as an HDD or an SSD in which reading and reading can be performed, as necessary, and a volatile memory such as a RAM, as a storage medium, and includes a reaction determination information storage unit 31C. The reaction determination information storage unit 31C is used to store the reaction determination information transmitted from the plurality of listener terminals UT1 to UTn.

The control unit 1C includes, as processing functions according to an embodiment of the present invention, a reaction determination information reception processing unit 11C, an action aggregation processing unit 12C, an opinion aggregation processing unit 13C, a vibration presentation control information generation processing unit 14C, a temperature presentation control information generation processing unit 15C, and a presentation control information transmission processing unit 16C. Each of the processing units 11C to 16C is implemented by causing a hardware processor of the control unit 1C to execute an application program stored in the program storage unit 2C.

The reaction determination information reception processing unit 11C receives the reaction determination information transmitted from each of the listener terminals UT1 to UTn via the communication I/F unit 4C, and performs processing for storing each received reaction determination information in the reaction determination information storage unit 31C.

The action aggregation processing unit 12C selects and reads information indicating a determination result of an action from each of the reaction determination information stored in the reaction determination information storage unit 31C. Then, based on the read information indicating the determination result of each action, processing for generating action aggregation information in which actions of the plurality of listeners to the speech content of the speaker are aggregated is performed. A specific action aggregation processing scheme will be described in an operation example.

The opinion aggregation processing unit 13C selects and reads information indicating a determination result of each of the opinions from each of the reaction determination information stored in the reaction determination information storage unit 31C. Then, based on the read information indicating the determination result of each of the foregoing opinions, processing for generating opinion aggregation information obtained by aggregating the opinions of the plurality of listeners about the speech content of the speaker is performed. A specific aggregation processing scheme for the opinions will also be described in an operation example.

The vibration presentation control information generation processing unit 14C performs processing for generating vibration control information obtained by converting an aggregation result of actions into intensity of vibration based on the action aggregation information generated by the action aggregation processing unit 12C.

The temperature presentation control information generation processing unit 15C performs processing for generating temperature control information obtained by converting the aggregation result of opinions into a level of temperatures based on the opinion aggregation information generated by the opinion aggregation processing unit 13C.

The presentation control information transmission processing unit 16C generates presentation control information in which the vibration presentation control information generated by the vibration presentation control information generation processing unit 14C and the temperature presentation control information generated by the temperature presentation control information generation processing unit 15C are inserted into, for example, one packet. Then, processing for transmitting the generated presentation control information from the communication I/F unit 4C to the speaker terminal ET is performed.

### (2-3) Speaker Terminal ET

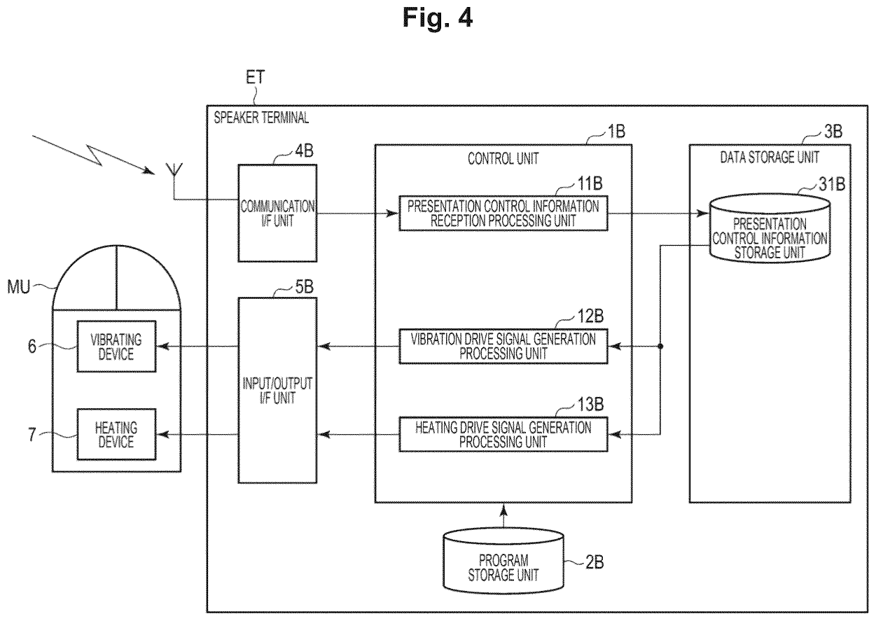

FIG. 4 is a block diagram illustrating an example of a hardware and software configuration of the speaker terminal ET.

As in the above-described listener terminals UT1 to UTn, the speaker terminal ET is also a personal computer that has an online conference function.

The speaker terminal ET includes a control unit 1B in which a hardware processor such as a central processing unit (CPU) is used. Then, a storage unit including a program storage unit 2B and a data storage unit 3B, a communication I/F unit 4B, and an input/output I/F unit 5B are connected to the control unit 1B via a bus (not illustrated).

The communication I/F unit 4B performs data communication with the server apparatus SV in conformity with a communication protocol defined by the network NW under the control of the control unit 1B.

An input/output device (not illustrated) including, for example, a keyboard and a display, and a mouse MU are connected to the input/output I/F unit 5B. The mouse MU includes a vibrating device 6 and a heating device 7 in addition to an input unit that performs normal operations such as click and scroll operations.

The vibrating device 6 includes, for example, a small motor and performs a vibration operation with intensity designated by a vibration drive signal when the vibration drive signal is given. The heating device 7 includes, for example, a Peltier element, and performs heating or cooling operation at a temperature designated by a heating drive signal when the heating drive signal is given.

The program storage unit 2C is configured by combining, for example, a nonvolatile memory such as an SSD capable of performing writing and reading, as necessary, and a nonvolatile memory such as a ROM as a storage medium, and stores an application program necessary for executing various control processes according to an embodiment, in addition to middleware such as an OS. Hereinafter, the OS and each application program are collectively referred to as a program.

The data storage unit 3B is, for example, a combination of a nonvolatile memory such as an SSD in which reading and reading can be performed, as necessary, and a volatile memory such as a RAM, as storage media, and includes a presentation control information storage unit 31B as main storage units necessary for carrying out one embodiment.

The presentation control information storage unit 31B stores the presentation control information transmitted from the server apparatus SV for a period until a presentation operation is performed.

The control unit 1B includes a presentation control information reception processing unit 11B, a vibration drive signal generation processing unit 12B, and a heating drive signal generation processing unit 13B as processing functions necessary for carrying out one embodiment. Each of the processing units 11B to 13B is realized by causing a hardware processor of the control unit 1B to execute an application program stored in the program storage unit 2B. The application program may be downloaded from the server apparatus SV as necessary and stored in the program storage unit 2B, in addition to being stored in advance in the program storage unit 2B.

The presentation control information reception processing unit 11B performs processing for receiving the presentation control information transmitted from the server apparatus SV via the communication I/F unit 4B and storing the received presentation control information in the presentation control information storage unit 31B.

The vibration drive signal generation processing unit 12B reads the vibration presentation control information from the presentation control information stored in the presentation control information storage unit 31B. Then, processing for generating a vibration drive signal based on the read vibration presentation control information and outputting the generated vibration drive signal to the vibrating device 6 of the mouse MU via the input/output I/F unit 5B is performed.

The heating drive signal generation processing unit 13B reads the temperature presentation control information from the presentation control information stored in the presentation control information storage unit 31B. Then, processing for generating a heating drive signal based on the read temperature presentation control information and outputting the generated heating drive signal to the heating device 7 of the mouse MU via the input/output I/F unit 5B is performed.

### Operation Example

Next, a reaction presentation operation performed in the online conference system that has the foregoing configuration will be described.

### (1) Listener Reaction Determination Processing in Listener Terminals UT1 to UTn

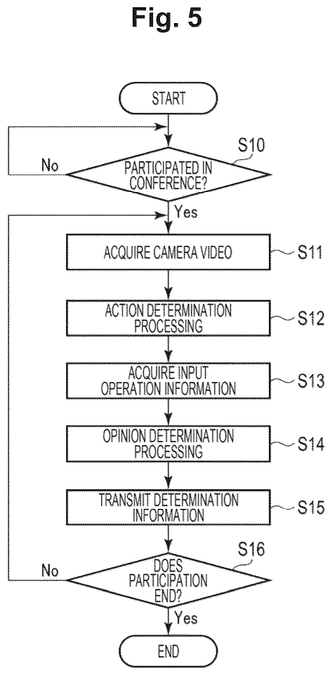

FIG. 5 is a flowchart illustrating a processing procedure and processing content of reaction determination processing performed by the control unit 1A of each of the listener terminals UT1 to UTn.

In step S10, the control unit 1A of each of the listener terminals UT1 to UTn monitors whether the listener participates in the online conference. In this state, when the listener performs an access operation to participate in the online conference, the control unit 1A performs a procedure of forming a conference communication link with the server apparatus SV under the control of the application program for the online conference. Thus, the user can participate in the online conference later.

### (1-1) Determination of Action

When the online conference is started, the control unit 1A of each of the listener terminals UT1 to UTn first captures video data obtained by imaging the face or the upper body of a listener from the camera 51 in step S11 via the input/output I/F unit 5A under the control of the action determination processing unit 11A while performing transmission/reception processing for various types of data related to the normal online conference. Then, in step S12, an action in which a reaction of the listener to the speaker is reflected is determined as follows, for example, based on the captured video data.

That is, the action determination processing unit 11A determines the presence or absence of a “nodding” action of the listener by performing image recognition processing on the video data using, for example, a basic image pattern for action determination prepared in advance. Then, the presence or absence of the “nodding” action is replaced with, for example, numerical values of “1” and “−1”, and the replaced numerical value is temporarily stored in the action determination information storage unit 31A as information indicating a determination result of an action indicating a reaction of the listener to the speaker at this time.

The action indicating the reaction of the listener may be another reaction action such as “shaking head”, “raising a hand”, “applauding”, or “laughing”, and is not limited to the type of action.

### (1-2) Determination of Opinion

At the same time, the control unit 1A of each of the listener terminals UT1 to UTn captures information indicating an opinion input by the listener with the input device 52 via the input/output I/F unit 5A in step S13 under the control of the opinion determination processing unit 12A. Then, in step S14, processing for determining an opinion of the listener about the speech content of the speaker is performs as follows, for example, based on the captured input information.

That is, the opinion determination processing unit 12A monitors which is operated between the two software buttons of “approval” and “disapproval” which are displayed on a display, for example, while the speaker is speaking or after the speaker finishes the speaking. Then, when any one of the buttons is operated, the input information corresponding to the operated button, that is, the input information indicating “approval” or “disapproval” is replaced with, for example, numerical values of “1” and “−1”, respectively, and the replaced numerical values are temporarily stored in the opinion determination information storage unit 32A as information indicating the determination result of the opinion of the listener.

As a scheme of inputting and determining an opinion, instead of providing an input device that has a hardware button dedicated to a reply or providing an input button, for example, the opinion of the listener may be determined by performing image recognition on predetermined expressing actions of “approval” and “disapproval” from video data captured by the camera 51 used for the action determination. An opinion is not limited to “approval” and “disapproval” and for example, an input of another opinion such as “next” or “talk more” may be received and the result may be determined.

### (1-3) Transmission Processing for Reaction Determination Information

Subsequently, under the control of the reaction determination information transmission processing unit 13A, in step S15, the control unit 1A of each of the listener terminals UT1 to UTn reads information indicating the action determination result and information indicating the opinion determination result from the action determination information storage unit 31A and the opinion determination information storage unit 32A, respectively, inserts the read information indicating each determination result into, for example, one packet, and transmits the packet as reaction determination information from the communication I/F unit 4A to the server apparatus SV.

The transmission processing for the reaction determination information may be performed periodically at a preset cycle or may be performed only when a significant result is obtained as a determination result of an action or an opinion.

Finally, in step S16, the control unit 1A of each of the listener terminals UT1 to UTn determines ending of participation in the online conference. Then, when the participation ending operation is not performed and the user continues to participate in the conference, the processing returns to step S11, and a series of reaction determination processing in steps S11 to S15 is repeatedly performed. Conversely, when the participation ending operation in the conference is performed, a procedure of disconnecting the conference communication link with the server apparatus SV is performed, and a return to a standby state is performed.

### (2) Reaction Presentation Control Processing in Server Apparatus SV

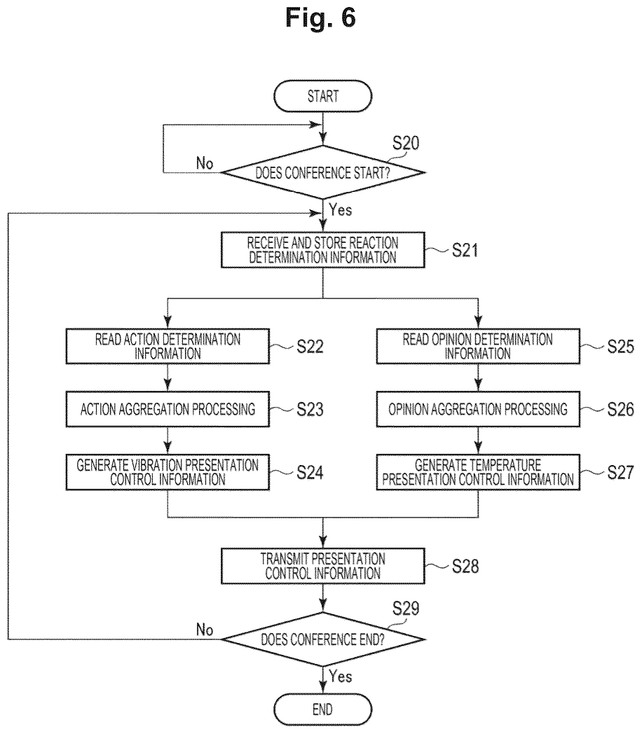

FIG. 6 is a flowchart illustrating a processing procedure and processing content of reaction presentation control processing performed by the control unit 1C of the server apparatus SV.

In step S20, the control unit 1C of the server apparatus SV monitors, for example, a conference start request transmitted from a terminal used by an organizer. When the conference start request is received in this state, under the control of the online conference application program, a communication link for the online conference is set between the speaker terminal ET that has transmitted the subsequent participation request and each of the plurality of listener terminals UT1 to UTn, and the online conference is enabled later.

### (2-1) Acquisition Processing for Reaction Determination Information

During a conference period, the control unit 1C of the server apparatus SV receives the reaction determination information transmitted from each of the listener terminals UT1 to UTn via the communication I/F unit 4C in step S21 under the control of the reaction determination information reception processing unit 11C, and stores each received reaction determination information in the reaction determination information storage unit 31C.

In order to associate a reaction of each listener with the speech of the speaker, a certain reception waiting period is set as an acquisition period of the reaction determination information, and each piece of reaction determination information received within this period is stored as reaction determination information for one speech in the reaction determination information storage unit 31C.

### (2-2) Action Aggregation Processing

When the acquisition of the reaction determination information in the reception standby period is completed, the control unit 1C of the server apparatus SV first selects and reads the action determination information from each piece of the reaction determination information of the plurality of listeners stored in the reaction determination information storage unit 31C in step S22 under the control of the action aggregation processing unit 12C. Then, in step S23, the read action determination information of the plurality of listeners is aggregated as follows, for example.

That is, the action aggregation processing unit 12C first calculates a total sum of a numerical value of “1” indicating “nodding” among the pieces of action determination information, and calculates an action aggregation index Aall by dividing the calculated total sum by the number of listeners participating in the conference. For example, when there are 100 listeners who are currently participating in the conference, and it is determined that 70 listeners among the listeners have nodded in response to a certain speech of the speaker, the action aggregation processing unit 12C calculates Aall=0.7 as the action aggregation index.

### (2-3) Generation Processing for Vibration Presentation Control Information

Subsequently, the control unit 1C of the server apparatus SV generates vibration presentation control information in step S24, for example, as follows under the control of the vibration presentation control information generation processing unit 14C.

That is, the vibration presentation control information generation processing unit 14C sets 0.5 as a determination threshold in order to determine whether the number of nodding listeners exceeds a majority, and compares the calculated action aggregation index Aall with the determination threshold of 0.5. Then, when a result of the comparison is Aall>0.5, that is, when the number of listeners who have nodded exceeds the majority, “ON” for generating vibration is set as vibration presentation control information. Conversely, when Aall≤0.5, that is, when the number of listeners who have nodded does not exceed the majority, “OFF” for not generating vibration is set as the vibration presentation control information. As a result, for example, as described above, when the action aggregation index is Aall=0.7, the vibration presentation control information in which vibration “on” is set is generated.

The determination threshold can be arbitrarily set such as a value other than 0.5, for example, 0.3 or 0.25 according to the purpose.

### (2-4) Opinion Aggregation Processing

When the acquisition processing for the reaction determination information in the reception standby period ends, the control unit 1C of the server apparatus SV selects and reads the opinion determination information from each piece of the reaction determination information of the plurality of listeners stored in the reaction determination information storage unit 31C in step S25 under the control of the opinion aggregation processing unit 13C. Then, in step S26, the read opinion determination information of the plurality of listeners is aggregated as follows, for example.

In other words, the opinion aggregation processing unit 13C generates an opinion aggregation index Oall by dividing the total sum of listeners who have input “approval” among the plurality of listeners who are participating in the conference by the total number of listeners. For example, on the assumption that there are 100 listeners participating in the conference now, and among these listeners, the number of listeners expressing “approval” (numerical value of “1”) is 60, and the number of listeners expressing “disapproval” (numerical value of “−1”) is 40, the opinion aggregation index Oall is calculated as follows.

$$\begin{matrix}Oall = ( 1 \times 60 - 1 \times 40 ) / 100 \\ = 0.2\end{matrix}$$

As a calculation formula of the opinion aggregation index Oall, any calculation formula may be used as long as a ratio of opinions is taken into consideration within a range of satisfying the condition of −1≤Aall≤1.

### (2-5) Generation Processing for Temperature Presentation Control Information

Subsequently, the control unit 1C of the server apparatus SV generates temperature presentation control information based on the calculated opinion aggregation index Oall in step S27 as follows under the control of the temperature presentation control information generation processing unit 15C.

That is, in this example, it is assumed that temperature presentation is performed so that warming is performed when the number of listeners expressing “approval” is large among the listeners who are participating in the conference, and cooling is performed when the number of listeners expressing “disapproval” is large. In this case, on the assumption that a reference temperature is Tbase, a maximum change temperature in the case of warming is ΔThot, and a maximum change temperature in the case of cooling is ΔTcold, the temperature presentation control information generation processing unit 15C determines the following presentation temperatures and sets the presentation temperatures as temperature presentation control information:

if Oall>0, T=Tbase+Oall×ΔThot;

if Oall<0, T=Tbase−Oall×ΔTcold; and

if Oall=0, T=Tbase.

As a result, for example, it is assumed that the reference temperature Tbase=25° C. is set, the maximum change temperature ΔThot=10° C. is set in the case of warming, and the maximum change temperature ΔTcold=5° C. is set in the case of cooling. In this example, because of Oall>0, the presentation temperature T can be set to

$$\begin{matrix}T = 25 + 0.2 \times 10 \\ = 27 ° C .\end{matrix}$$

A calculation formula of the presentation temperature T is not limited to the above example and may be, for example, Oall and ΔThot or ΔTcold multiplied by a constant k larger than 0 and equal to or smaller than 1.

That is,

If Oall>0, Tbase+k×Oall×ΔThot; and

if Oall<0, Tbase−k×Oall×ΔTcold.

Here, k is 0<k≤1, and k=1 is set in this example.

### (2-6) Output of Presentation Control Information

When the vibration presentation control information and the temperature presentation control information are generated as described above, the control unit 1C of the server apparatus SV performs transmission processing as follows in step S28 under the control of the presentation control information transmission processing unit 16C.

That is, the presentation control information transmission processing unit 16C inserts the generated vibration presentation control information and temperature presentation control information into, for example, one packet in a state where the information is associated with each other to simultaneously present the vibration presentation control information and the temperature presentation control information. Then, the packet is transmitted from the communication I/F unit 4C to the speaker terminal ET.

When the transmission of the presentation control information is completed, the control unit 1C of the server apparatus SV determines, in step S29, whether an online conference ending operation has been performed with, for example, an organizer terminal. Then, when the ending operation is not detected and the conference is continuing, the processing returns to step S21 and the series of above-described reaction presentation control processing is repeatedly performed in steps S21 to S28. Conversely, when the ending of the conference is detected, the communication link for the online conference between the speaker terminal ET and each of the listener terminals UT1 to UTn is disconnected and the return to the standby state is performed.

### (3) Reaction Presentation Processing in Speaker Terminal ET

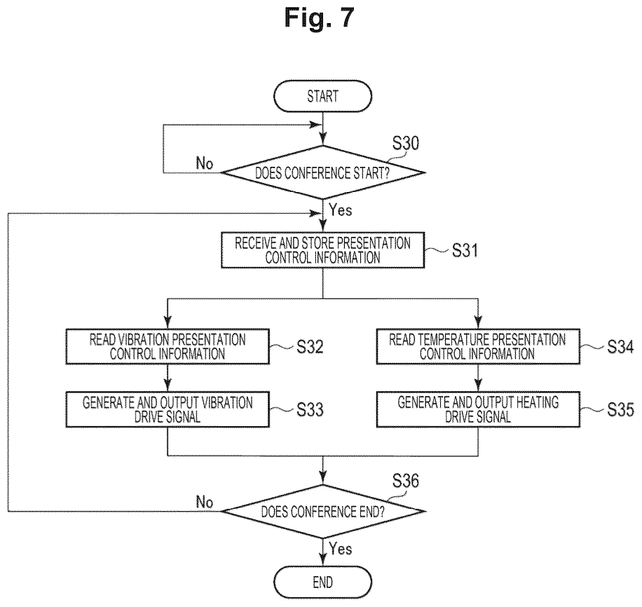

FIG. 7 is a flowchart illustrating a processing procedure and processing content of the reaction presentation processing performed by the control unit 1B of the speaker terminal ET.

In step S30, the control unit 1B of the speaker terminal ET monitors presence or absence of the participation operation of the speaker in the online conference. In this state, when the speaker performs an access operation to participate in the online conference, the control unit 1B performs a procedure of forming a conference communication link with the server apparatus SV under the control of the application program for the online conference. Thus, the user can participate in the online conference later.

### (3-1) Reception Processing for Presentation Control Information

When the online conference is started, the control unit 1B of the speaker terminal ET receives the presentation control information transmitted from the server apparatus SV via the communication I/F unit 4B in step S31 under the control of the presentation control information reception processing unit 11B while performing transmission or reception processing for various data related to the normal online conference. Then, the received presentation control information is temporarily stored in the presentation control information storage unit 31B.

### (3-2) Generation and Output of Vibration Drive Signal

When the presentation control information is received, the control unit 1B of the speaker terminal ET first selectively reads the vibration presentation control information included in the presentation control information from the presentation control information storage unit 31B in step S32 under the control of the vibration drive signal generation processing unit 12B. In step S33, the vibration drive signal generation processing unit 12B generates a vibration drive signal based on the read vibration presentation control information.

For example, when the vibration presentation control information is set to vibration “ON”, a vibration drive signal for generating vibration with preset intensity is generated. Then, the vibration drive signal generation processing unit 12B outputs the generated vibration drive signal from the input/output I/F unit 5B to the vibrating device 6 built in the mouse MU. As a result, the vibrating device 6 vibrates at the intensity designated by the vibration drive signal for a certain time. That is, the mouse MU vibrates at a predetermined intensity for the certain time in accordance with the aggregated nodding motion of the plurality of listeners.

Conversely, when the vibration presentation control information is set to vibration “OFF”, the vibration drive signal generation processing unit 12B does not generate the vibration drive signal. Therefore, the mouse MU does not vibrate, and the nodding motion of the listeners is not presented to the speaker.

### (3-3) Generation and Output of Heating Drive Signal

The control unit 1B of the speaker terminal ET selectively reads the temperature presentation control information included in the presentation control information from the presentation control information storage unit 31B in step S34 under the control of the heating drive signal generation processing unit 13B in parallel with generation and output processing for the vibration drive signal. In step S35, the heating drive signal generation processing unit 13B generates a heating drive signal based on the read temperature presentation control information.

For example, if the presentation temperature T currently set in the temperature presentation control information designates warming, the heating drive signal generation processing unit 13B generates a heating drive signal for generating the designated presentation temperature T for designating warming. Then, the generated heating drive signal is supplied to the heating device 7 of the mouse MU via the input/output I/F unit 5B. As a result, the heating device 7 generates heat at the temperature designated by the heating drive signal. Accordingly, due to the heating of the mouse MU, the speaker can recognize that the result of aggregation of the opinions of the listeners about his or her speech is generally “approval”.

Conversely, when the presentation temperature T set in the temperature presentation control information designates cooling, the heating drive signal generation processing unit 13B generates a heating drive signal for generating the presentation temperature T for designating the cooling. Then, the generated heating drive signal is supplied to the heating device 7 of the mouse MU via the input/output I/F unit 5B. As a result, the heating device 7 operates to cool the mouse MU to the temperature designated by the heating drive signal. Accordingly, by cooling the mouse MU, the speaker can recognize that the result of aggregation of the opinions of the listeners about his or her speech is substantially “disapproval”.

Finally, the control unit 1B of the speaker terminal ET determines ending of the participation in the online conference in step S36. When the participation ending operation is not performed and the listeners continue to participate in the conference, the processing returns to step S31, and a series of reaction presentation processing of steps S31 to S35 is repeatedly performed. Conversely, when the participation ending operation in the conference is performed, the procedure of disconnecting the conference communication link with the server apparatus SV is performed, and the return to the standby state is performed.

### Operations and Effects

As described above, in the online conference system according to one embodiment, the following operation is performed. That is, the plurality of listener terminals UT1 to UTn participating in the online conference include the presence or absence of “nodding” representing the reactions of the listeners to the speech of the speaker and the determination result of “approval or disapproval” input by the listeners in the reaction determination information as the action determination information and the opinion determination information, respectively, and transmit the information to the server apparatus SV. On the other hand, when the reaction determination information is received from the listener terminals UT1 to UTn, the server apparatus SV aggregates the actions and the opinions of the plurality of listeners participating in the conference based on the action determination information and the opinion determination information included in the reaction determination information. Then, the vibration presentation control information indicating the aggregation result of the action by the intensity of vibration is generated, the temperature presentation control information indicating the aggregation result of the opinions by the level of temperature is generated, and each piece of generated presentation control information is transmitted to the speaker terminal ET. The speaker terminal ET generates a vibration drive signal in accordance with the received vibration presentation control information to vibrate the vibrating device 6 of the mouse MU, and generates a heating drive signal in accordance with the received temperature presentation control information to heat or cool the heating device 7 of the mouse MU.

Accordingly, the speaker can recognize the reactions of the listeners to his or her speech in detail without depending on the visual display, that is, without generating a new recognition load, by combining the vibration presented in the mouse MU and the heating or the cooling operation.

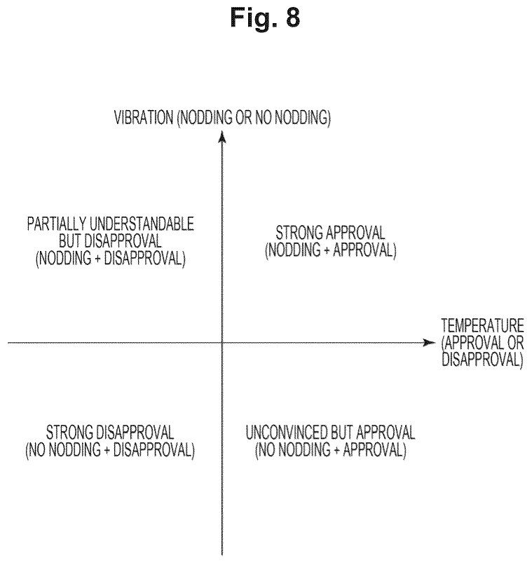

FIG. 8 illustrates four types of reactions presented in one embodiment in a two-dimensional space formed by vibration and temperature. As illustrated in FIG. 8, when vibration is generated and a heating action is performed, “strong approval” is presented to the speaker. Conversely, when vibration is not generated and a cooling operation is performed, “strong disapproval” is presented to the speaker. When vibration is generated and the cooling operation is performed, “partially understandable but disapproval” is presented to the speaker. When vibration is not generated and the heating operation is performed, “unconvinced but approval” is presented to the speaker.

### Other Embodiments

(1) In the foregoing embodiment, the case where presence or absence of nodding of the listeners is represented by the presence or absence of vibration generation has been described as an example. However, the presence or absence of nodding may be represented with the intensity of vibration or may be represented by varying a generation time length and a generation pattern (for example, an intermittent pattern) of vibration. Further, the present invention is not limited to the presence or absence of nodding of the listeners, and magnitude of the nodding may be determined at a plurality of stages, and the determined magnitude of the nodding may be presented by varying the intensity of vibration at a plurality of stages.
(2) In the foregoing embodiment, the case where the opinions (approval and disapproval) input by the listeners are expressed with a level of the temperature (heating and cooling) have been described as an example. However, the opinions (approval and disapproval) may be expressed by the presence or absence of heating or the presence or absence of cooling. Further, the opinions of the listeners may be determined at a plurality of stages, for example, “great approval”, “partial approval”, “great disapproval”, and “partial disapproval” instead of an alternative of approval or disapproval, and the determined stage of the opinions may be presented by varying the level of temperature at a plurality of stages.
(3) In the foregoing embodiment, the case where the vibrating device 6 and the heating device 7 are provided in the mouse MU has been described as an example. However, otherwise, for example, the vibrating device and the heating device may be provided on a wearable terminal worn by the speaker on his or her body, a wristwatch, a bracelet, glasses, clothing, or the like.
(4) In the foregoing embodiment described above, the case where the processing for aggregating actions and opinions and the processing for generating the presentation control information of vibration and temperature based on the aggregated actions and opinions are performed in the server apparatus SV has been described as an example. However, the present invention is not limited thereto. For example, the reaction determination information transmitted from the plurality of listener terminals UT1 to UTn may be directly transmitted to the speaker terminal ET via a network, and the speaker terminal ET may perform each processing performed by the server apparatus SV.
(5) In the foregoing embodiment, the online conference system has been described as an example. However, the present invention may be carried out in, for example, an online lecture, a lecture, or an online exhibition. Further, the present invention may be carried out not only in an online conference but also in an offline conference, a lecture, an exhibition, or the like performed in a face-to-face manner.
(6) In addition, configurations, processing functions, processing procedures, processing content, and the like of the listener terminals, the speaker terminal, and the server apparatus can be variously modified and implemented without departing from the gist of the present invention.

Although the embodiments of the present invention have been described above in detail, the foregoing description is merely an example of the present invention in all respects. It is needless to say that various improvements and modifications can be made without departing from the scope of the present invention. That is, a specific configuration according to an embodiment may be appropriately adopted to carry out the present invention.

In short, the present invention is not limited to the above-described embodiments without any change, and can be embodied by modifying the constituent elements without departing from the gist of the present invention at implementation stages. Various inventions can be embodied by appropriately combining a plurality of the constituents disclosed in the foregoing embodiments. For example, some constituents may be omitted from the entire constituents described in the embodiments. Further, the constituents in different embodiments may be appropriately combined.

### REFERENCE SIGNS LIST

SV Server apparatus
UT1 to UTn Listener terminal
ET Speaker terminal
NW Network
1A, 1B, 1C Control unit
2A, 2B, 2C Program storage unit
3A, 3B, 3C Data storage unit
4A, 4B, 4C Communication I/F unit
5A, 5B Input/output I/F
11A Action determination processing unit
12A Opinion determination processing unit
13A Reaction determination information transmission processing unit
11B Presentation control information reception processing unit
12B Vibration drive signal generation processing unit
13B Heating drive signal generation processing unit
11C Reaction determination information reception processing unit
12C Action aggregation processing unit
13C Opinion aggregation processing unit
14C Vibration presentation control information generation processing unit
15C Temperature presentation control information generation processing unit
16C Presentation control information transmission processing unit
31A Action determination information storage unit
32A Opinion determination information storage unit
31B Presentation control information storage unit
31C Reaction determination information storage unit

1. A reaction presentation control apparatus comprising:
acquisition processing circuitry configured to acquire information indicating each of reaction states of a plurality of listeners to speech content of a speaker:
reaction aggregation information generation processing circuitry configured to generate reaction aggregation information obtained by aggregating the reaction states of the plurality of listeners based on the acquired information indicating the reaction states: and
output processing circuitry configured to generate control information for variably controlling vibration and temperature based on the generated reaction aggregation information and to output the generated control information to be presented to the speaker.

2. The reaction presentation control apparatus according to claim 1, wherein:
the acquisition processing circuitry acquires information indicating the reaction states of the plurality of listeners from a plurality of listener terminals used by each of the plurality of listeners via a network, and
the output processing circuitry transmits the control information to a speaker terminal used by the speaker via the network.

3. The reaction presentation control apparatus according to claim 1, wherein:
the acquisition processing circuitry acquires, as the information indicating the reaction states, information indicating body motions reflecting the reactions of the listeners and information indicating opinions input by the listeners,
the reaction aggregation information generation processing circuitry includes
first aggregation processing circuitry that generates first aggregation information obtained by aggregating the motions of the plurality of listeners based on the acquired information indicating the body motions, and
second aggregation processing circuitry that generates second aggregation information obtained by aggregating the opinions of the plurality of listeners based on the acquired information indicating the opinions, and
the output processing circuitry includes
first control information generation processing circuitry that generates and outputs vibration control information indicating the body motions of the plurality of listeners in accordance with intensity of vibration based on the generated first aggregation information, and
second control information generation processing circuitry that generates and outputs temperature control information indicating the opinions of the plurality of listeners in accordance with a level of the temperature based on the generated second aggregation information.

4. The reaction presentation control apparatus according to claim 3, wherein:
the first aggregation processing circuitry generates the first aggregation information indicating a degree of nodding of the plurality of listeners based on information indicating the degree of nodding of the listeners, and
the first control information generation processing circuitry generates and outputs the vibration control information obtained by converting the degree of nodding into magnitude of the vibration.

5. The reaction presentation control apparatus according to claim 3, wherein:
the second aggregation processing circuitry generates the second aggregation information indicating a degree of approval or disapproval of the plurality of listeners based on information indicating the degree of approval or disapproval of the listener, and
the second control information generation processing circuitry generates and outputs the temperature control information obtained by converting the degree of approval or disapproval into the level of the temperature.

6. The reaction presentation control apparatus according to claim 5, wherein;
the second control information generation processing circuitry generates and outputs, as the temperature control information, information for performing control such that the degree of approval or disapproval is warmed to a first temperature higher than a preset reference temperature or the degree of approval or disapproval is cooled to a second temperature lower than the reference temperature.

7. A reaction presentation control method, comprising:
acquiring information indicating reaction states of a plurality of listeners to speech content of a speaker in an event;
generating reaction aggregation information obtained by aggregating the reaction states of the plurality of listeners based on the acquired information indicating the reaction states; and
generating control information for variably controlling vibration and temperature based on the generated reaction aggregation information and outputting the generated control information to be represented to the speaker.

8. A non-transitory computer readable medium storing a program causing a processor to perform the method of claim 7.
